(19) United States
(12) Patent Application Publication
(10) Pub. No.: US 2024/0080226 A1
(43) Pub. Date: Mar. 7, 2024

(54) METHODS AND APPARATUS FOR CHANNEL ESTIMATION FOR LOW RESOLUTION ANALOG TO DIGITAL CONVERTER

(71) Applicant: HUAWEI TECHNOLOGIES CO., LTD., SHENZHEN, GUANGDONG (CN)

(72) Inventors: Mostafa MEDRA, KANATA (CA); Mohammadhadi BALIGH, OTTAWA (CA)

(21) Appl. No.: 18/503,155

(22) Filed: Nov. 6, 2023

Related U.S. Application Data
(63) Continuation of application No. PCT/CN2021/092569, filed on May 10, 2021.

(51) Int. Cl. H04L 25/02; H04L 5/00

(52) U.S. Cl. CPC H04L 25/0228; H04L 5/0051

(57) ABSTRACT

Aspects of the present disclosure provide using pilot sequences that are better suited to hardware capabilities of a receiver, in particular the capabilities of an analog to digital converter (ADC). When the pilot sequence changes, in amplitude or phase, the received pilot symbols may be quantized to different quantization regions. By utilizing a particular pilot sequence, it may be possible to extract additional information from the pilot sequence being quantized over multiple quantization regions instead of only a single quantization region. Therefore, by careful selection of the pilot sequence taking into consideration capabilities of the receiver, it may be possible to obtain more accurate channel estimations.

### CROSS-REFERENCE TO RELATED APPLICATIONS

This application is a continuation of International Patent Application No. PCT/CN2021/092569, filed May 10, 2021, entitled “METHODS AND APPARATUS FOR CHANNEL ESTIMATION FOR LOW RESOLUTION ANALOG TO DIGITAL CONVERTER”, the contents of which is incorporated by reference herein its entirety.

### TECHNICAL FIELD

The present disclosure relates generally to wireless communications, and in particular embodiments, to using a channel estimation for low resolution analog to digital converter (ADC).

### BACKGROUND

In some wireless communication systems, user equipments (UEs) wirelessly communicate with a base station to send data to the base station and/or receive data from the base station. A wireless communication from a UE to a base station is referred to as an uplink (UL) communication. A wireless communication from a base station to a UE is referred to as a downlink (DL) communication. A wireless communication from a first UE to a second UE is referred to as a sidelink (SL) communication or device-to-device (D2D) communication.

Resources are required to perform uplink, downlink and sidelink communications. For example, a base station may wirelessly transmit data, such as a transport block (TB), to a UE in a downlink transmission at a particular frequency and over a particular duration of time. The frequency and time duration used are examples of resources.

Conventional systems use (orthogonal) pilot sequences so that a multi-user system can perform channel estimation. UEs may be equipped with a high resolution analog to digital converter (ADC) because the number of antennas is typically low at lower transmission frequencies. A high resolution ADC may be considered an ADC having a resolution of 5 bits, 6 bits or more than 6 bit resolution. When systems started using higher transmission frequencies, which have a correspondingly smaller wavelength, the smaller wavelength allowed more antennas to be located in a smaller space, thereby improving a communication link between a transmitter and a receiver. However, power consumption grows with an increased number of radio frequency (RF) chains that may result from a higher number of antennas. One of the main causes of power consumption in a RF chain is the ADC. The power consumption of an ADC depends on a sampling rate used by the ADC and the ADC resolution. The power consumption may be linearly proportional to the sampling rate and exponentially proportional to the ADC resolution expressed in number of bits. At higher frequencies, the sampling rate may be high due to the possibly large bandwidth. A large power consumption may be a problem for the feasibility of high frequency communication.

Problems can arise when channel estimation is performed using a same pilot sequence for both low resolution ADCs and high resolution ADCs. A low resolution ADC may be considered an ADC having a resolution of 1 bits or 2 bits. While conventional pilot sequences work quite well for high resolution ADCs, these sequences are not tailored for low or 1-bit ADCs. Using the conventional pilot sequences for high resolution ADCs with a low or 1-bit ADCs can cause channel estimation error to be high. When the channel estimation is of poor quality, it can cause significant bit error rate/symbol error rate (BER/SER) causing the data transmission to be unreliable. Methods enabling the use of low resolution ADCs and mitigating channel estimation errors in communication systems would be beneficial.

### SUMMARY

Aspects of the present disclosure propose using pilot sequences that are better suited to the hardware capabilities of the receiver, in particular the capabilities of the ADC. Generally, it is assumed that the pilot sequence can change amplitude and/or phase angle in a predefined way, and that the receiver can obtain additional information regarding the channel using the changes in the pilot sequence. More specifically, when the pilot sequence that traverses the channel changes, the received pilot symbols may be quantized to different quantization regions. By utilizing a particular pilot sequence, it may be possible to extract additional information from the pilot sequence as it is quantized into multiple quantization regions instead of only a single quantization region. For example, a transition from one quantization region to another quantization region can provide additional control information. Therefore, by careful selection of the pilot sequence taking into consideration capabilities of the receiver, it may be possible to obtain more accurate channel estimations.

According to some aspects of the disclosure, there is provided a method and includes receiving, by a transmitter, channel estimation information of a receiver. The transmitter then selects a reference signal to be transmitted to the receiver, wherein the selection is based on the receiver channel estimation information. The transmitter then transmits the selected reference signal to the receiver. In some embodiments, the method may include receiving channel estimation feedback information from the receiver.

In some embodiments, the reference signal may be a demodulation reference signal (DMRS) associated with at least one of: physical downlink shared channel (PDSCH); physical uplink shared channel (PUSCH); or physical sidelink shared channel (PSSCH). In some embodiments, the reference signal is a channel state information reference signal (CSI-RS) or a sounding reference signal (SRS).

In some embodiments, selecting the reference signal includes the transmitter selecting the reference signal from a plurality of reference signals, wherein the selecting is performed based on channel estimation information capabilities of the receiver provided in the channel estimation information received from the receiver. In some embodiments, selecting the reference signal includes the transmitter selecting the reference signal as determined by the receiver and provided as a proposed reference signal in the channel estimation information received from the receiver.

In some embodiments, the transmitter may further transmit an indication of the selected reference signal to the receiver. The indication may be an identification of the reference signal selected by the transmitter or an acknowledgement of the reference signal selected by the receiver.

In some embodiments, the indication may be transmitted using radio resource control (RRC) signaling, media access control-control element (MAC-CE) messages or downlink control information (DCI).

The reference signal is one of: a reference signal sequence wherein symbols of the reference signal sequence have a varying phase angle ranging from Φₘᵢₙ to Φₘₐₓ and a constant amplitude, where Φₘᵢₙ is a minimum phase angle and Φₘₐₓ is a maximum phase angle of the varying phase angle; a reference signal sequence wherein symbols of the reference signal sequence have a varying phase angle from Φₘᵢₙ to Φₘₐₓ and a varying amplitude from Aₘᵢₙ to Aₘₐₓ, where Aₘᵢₙ is a minimum amplitude and Aₘₐₓ is a maximum amplitude of the varying amplitude; or a reference signal sequence wherein symbols of the reference signal sequence include a plurality of sets of symbols, each set comprising symbols having a varying phase angle from Φₘᵢₙ to Φₘₐₓ and a constant amplitude and each set having a different constant amplitude.

In some embodiments, at least one of the varying phase angle from Φₘᵢₙ to Φₘₐₓ and the varying amplitude from Aₘᵢₙ to Aₘₐₓ of the symbols causes a transition from a first quantization region to a second quantization region when quantized by an analog-to-digital converter (ADC) in the receiver and information from the resulting quantization regions and the transition from the first quantization region to the second quantization region is used to estimate the channel.

In some embodiments, transition from the first quantization region to the second quantization region is used to provide control information or channel information to the receiver.

In some embodiments, when the ADC in the receiver is a 1 bit resolution ADC, a range of the phase angle from Φ min to Φ max is at least 90°.

In some embodiments, the reference signal sequence occurs on a narrow band for use with a frequency selective channel. In other embodiments the reference signal sequence occurs on a wider band for use with a flat channel.

In some embodiments the symbols of the reference sequence are arranged in a non-sequential arrangement of phase angle from symbol to symbol in the range of Φₘᵢₙ to Φₘₐₓ. In some embodiments the symbols of the reference sequence are arranged in a sequential arrangement of phase angle that is increasing or decreasing from symbol to symbol in the range of Φₘᵢₙ to Φₘₐₓ.

The channel estimation information may include one or more of: ADC number of bits; decision threshold boundaries; quantization outputs; sampling rate; oversampling ratio; or desired accuracy.

In some embodiments, the reference signal is suitable for at least one: different ADC resolutions; different signal to noise ratio (SNR) or signal-to-interference plus noise ratio (SINR) values; or different operating bandwidths.

In some embodiments, when the transmitter receives channel estimation information from multiple receivers, the selecting, by the transmitter, the reference signal is based on the receiver channel estimation information of at least one of the multiple receivers.

In some embodiments, the reference signal sequence occurs with the symbols in the reference sequence being consecutively grouped together in the frame. In some embodiments, the reference signal sequence occurs with the symbols in the reference signal sequence being interleaved with data.

In some embodiments, the selecting the reference signal further comprises estimating signal to noise ratio (SNR) and quantization noise based on one or more of: measurements made by the transmitter; channel estimation capabilities of the receiver; measurement information received from the receiver; and default estimate values.

According to some aspects of the disclosure, there is provided a device including a processor and a computer-readable medium having stored thereon computer executable instructions. The computer executable instructions, when executed, cause the device to: receive channel estimation information from a receiver; select a reference signal to be transmitted to the receiver, wherein the selection is based on the receiver channel estimation information; and transmit the selected reference signal to the receiver.

According to some aspects of the disclosure, there is provided a method that includes transmitting, by a receiver, channel estimation information of the receiver. The receiver may then receive a reference signal, the reference signal being selected from a set plurality of reference signals based on the channel estimation information. The receiver may then perform channel estimation using the received reference signal. The receiver then transmits channel estimation feedback information based on the channel estimation.

In some embodiments, the receiver may receive a demodulation reference signal (DMRS), wherein the DMRS is associated with at least one of: physical downlink shared channel (PDSCH); physical uplink shared channel (PUSCH); or physical sidelink shared channel (PSSCH). In some embodiments, the reference signal is a channel state information reference signal (CSI-RS) or a sounding reference signal (SRS).

In some embodiments, the receiver may select the reference signal from the plurality of reference signals, wherein the selection is performed based on channel estimation capabilities of the receiver and may involve including the selected reference signal in the channel estimation information that is transmitted to the transmitter.

In some embodiments, the reference signal in the plurality of reference signals is one of: a reference signal sequence wherein symbols of the reference signal sequence have a varying phase angle from Φₘᵢₙ to Φₘₐₓ and a constant amplitude, where Φₘᵢₙ is a minimum phase angle and Φₘₐₓ is a maximum phase angle of the varying phase angle; a reference signal sequence wherein symbols of the reference signal sequence have a varying phase angle from Φₘᵢₙ to Φₘₐₓ and a varying amplitude from Aₘᵢₙ to Aₘₐₓ, where Aₘᵢₙ is a minimum amplitude and Aₘₐₓ is a maximum amplitude of the varying amplitude; or a reference signal sequence wherein symbols of the reference signal sequence include a plurality of sets of symbols, each set comprising symbols having a varying phase angle from Φₘᵢₙ to Φₘₐₓ and a constant amplitude and each set having a different constant amplitude.

In some embodiments, the at least one of the varying phase angle from Φₘᵢₙ to Φₘₐₓ and the varying amplitude from Aₘᵢₙ to Aₘₐₓ of the symbols causes a transition from a first quantization region to a second quantization region when quantized by an analog-to-digital converter (ADC) and information from the resulting quantization region and the transition from the first quantization region to the second quantization region is used to estimate the channel. In some embodiments, the transition from the first quantization region to the second quantization region may be used to convey control information or channel information to the receiver.

Ins some embodiments, when the ADC in the receiver is a 1 bit resolution ADC, a range of the phase angle from Φ min to Φ max is at least 90°.

In some embodiments, the reference signal sequence occurs on a narrow band for use with a frequency selective channel. In other embodiments, the reference signal sequence occurs on a wider band for use with a flat channel.

In some embodiments, the symbols of the reference sequence are arranged in a non-sequential arrangement of phase angle from symbol to symbol in the range of Φₘᵢₙ to Φₘₐₓ. In some embodiments, the symbols of the reference sequence are arranged in a sequential arrangement of phase angle that is increasing or decreasing from symbol to symbol in the range of Φₘᵢₙ to Φₘₐₓ.

In some embodiments, receiver transmits an indication of analog-to-digital converter (ADC) properties of the receiver including one or more of: ADC number of bits; decision boundaries; quantization threshold outputs; sampling rate; oversampling ratio; or desired accuracy.

In some embodiments, the plurality of reference signals includes reference signals that are suitable for at least one of: different ADC resolutions; different signal to noise ratio (SNR) or signal-to-interference plus noise (SINR) values; or different operating bandwidths.

In some embodiments, the receiver receives an indication of the reference signal that will be transmitted to the receiver, wherein the indication is an identification of the reference signal selected by the transmitter or an acknowledgement of the reference signal selected by the receiver.

In some embodiments, receiving, by the receiver, the indication of the reference signal comprises receiving the indication using radio resource control (RRC) signalling, media access control-control element (MAC-CE) messages or downlink control information (DCI).

In some embodiments, after the receiver receives the indication of the reference signal, the receiver transmits a confirmation of the selected reference signal.

In some embodiments, the reference signal sequence occurs with the symbols in the reference sequence being consecutively grouped together in the frame. In some embodiments, the reference signal sequence occurs with the symbols in the reference signal sequence being interleaved with data.

According to some aspects of the disclosure, there is provided a device including a processor and a computer-readable medium having stored thereon computer executable instructions. The computer executable instructions, when executed, cause the device to: transmit channel estimation information of the device; receive a reference signal, the reference signal selected from a plurality of reference signals based on the channel estimation information; perform channel estimation using the received reference signal; and transmit channel estimation feedback information based on the channel estimation.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a block diagram of an ADC and a corresponding graphical plot showing a relationship between analog input signal and quantized digital output.

FIG. 2A is a schematic diagram of a communication system in which embodiments of the disclosure may occur.

FIG. 2B is another schematic diagram of a communication system in which embodiments of the disclosure may occur.

FIG. 3A is a block diagram illustrating example electronic devices and network devices.

FIG. 3B is a block diagram illustrating units or modules in a device.

FIG. 4 illustrates a graphical plot of an example of channel estimation based on a pilot sequence that has a varying phase angle component according to embodiments of the present disclosure.

FIG. 5 illustrates a graphical plot of another example channel estimation based on a pilot sequence that has a varying phase angle component according to an embodiment of the present disclosure.

FIG. 6A illustrates an example of how a pilot sequence selected based on capabilities of the receiver can be multiplexed with data according to an embodiment of the present disclosure.

FIG. 6B illustrates another example of how a pilot sequence selected based on capabilities of the receiver can be multiplexed with data according to an embodiment of the present disclosure.

FIGS. 7, 8 and 9 are examples of signaling flow diagrams for DL, UL and SL communications, respectively, that utilize a pilot sequence selected based on capabilities of the receiver.

### DETAILED DESCRIPTION OF ILLUSTRATIVE EMBODIMENTS

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

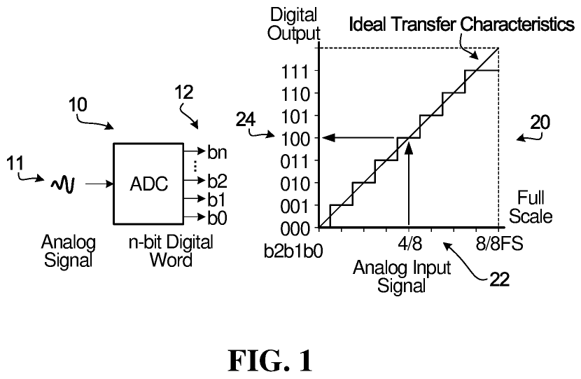

FIG. 1 shows an example of an Analog-to-Digital Converter (ADC) 10 receiving a continuous analog signal 11 as an input and outputting quantized digital values 12 at each of a series of sampling points. An ADC is typically performing the operation of, for a given point in time, i.e. the sample time occurring at sampling rate, quantizing the continuous analog value into a discrete number of quantization levels and then equating each of the quantization values to a digital, multiple bit word. The number of quantization levels determines the number of bits that may correspond to a digital sample, or vice versa. The ADC 10 is shown to output an n bit word 12, i.e. b₀b₁b₂ . . . bₙ, where each bit is a binary bit, either 0 or 1. Graph 20 shows a relationship between the analog input signal and a three bit word b₀b₁b₂ digital output. The graphical plot 20 has the analog input value on the horizontal axis and the digital output on the vertical axis. For the digital three bit word there are 8 possible quantization levels. In the graphical plot 20, it can be seen how an analog value 22 that is a value equal to half of the range from minimum magnitude of the signal to maximum magnitude of the signal is quantized to a value of 4 of the 8 quantization levels. Therefore, the quantization value of 4/8 22 is mapped to the digital 3 bit word “100” 24. The higher the number of bits in the n bit word, the higher the resolution of the digital output of the ADC.

Power consumption of the ADC may be linearly proportional to the sampling rate and exponentially proportional to the ADC resolution expressed in number of bits. One way to reduce power consumption may be to use a lower resolution ADC. A low resolution ADC having a resolution of, for example, 1 bit or 2 bits, will therefore have a lower power consumption than a high resolution ADC having a resolution of, for example, 5 bits or more.

The receiver in a communication system may use an ADC when performing a channel estimate. For example, a pilot or pilot signal may be transmitted by the transmitter and measured by the receiver, after the reference signal is converted from an analog signal that is received over the air at the receiver. The pilot signal may be a sequence of pilot symbols in a time and/or frequency resource. The reference signal may be considered a sequence of reference signal symbols in a time and/or frequency resource. In embodiments of the present disclosure, the pilot or pilot signal may be also referred to as a reference signal, a pilot sequence may be referred to as a reference signal sequence, and so on.

Conventional reference signal or pilot design is often based on finding sequences that have a compact frequency spectrum. For example, a Zadoff-Chu (ZC) sequence which has a constant amplitude and a certain phase angle design. These sequences usually have constant amplitude. However, these sequences are not optimized according to the hardware capabilities of the receiver.

Existing approaches that propose channel estimation using a low resolution ADC, i.e. an ADC with a small number of bits in the output word, include joint optimization of the pilot sequences and the pre-RF chain analog combiners having a goal of minimizing a sum of mean squared errors (MSEs) of the estimated channel vectors at a base station.

While conventional pilot sequences work quite well for high resolution ADCs, these sequences are not tailored for low or 1-bit ADCs. Using the conventional pilot sequences for high resolution ADCs with a low or 1-bit ADCs can cause channel estimation error to be high. When the channel estimation is of poor quality, it can cause significant bit error rate/symbol error rate (BER/SER) causing the data transmission to be unreliable.

Aspects of the present disclosure propose methods for using pilot sequences that are better suited to the hardware capabilities of the receiver, in particular the capabilities of the ADC. Generally, it is assumed that the pilot sequence can change at least one of amplitude and phase angle in a predefined way, and that the receiver can obtain additional information regarding the channel using the changes in the pilot sequence. More specifically, when the pilot sequence that traverses the channel changes, the received pilot symbols may be quantized to different quantization regions. By utilizing a particular pilot sequence, it may be possible to extract additional information from the pilot sequence as it is quantized into multiple quantization regions instead of only a single quantization region. For example, a transition from one quantization region to another quantization region can provide additional control information. In some embodiments, the additional control information may be related to information the transmitter is providing to the receiver about the channel. Therefore, by careful selection of the pilot sequence taking into consideration capabilities of the receiver, it may be possible to obtain more accurate channel estimations.

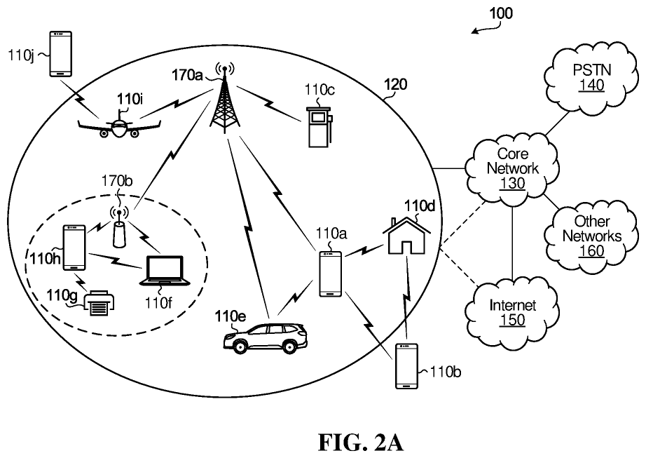

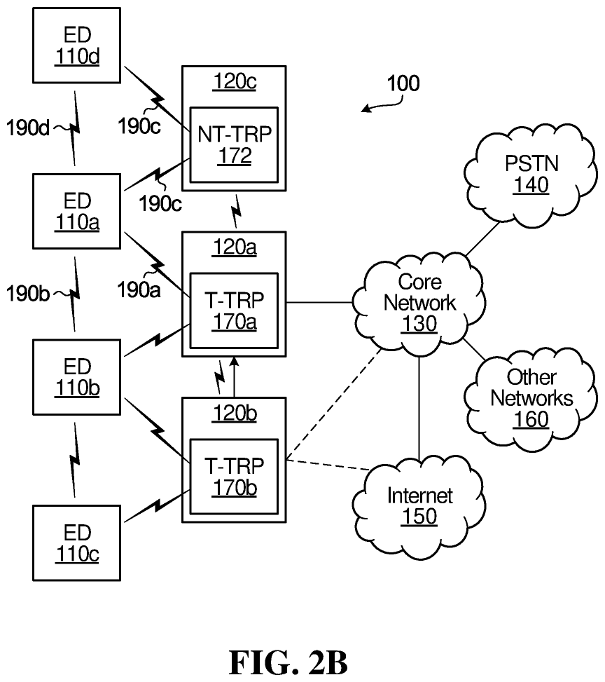

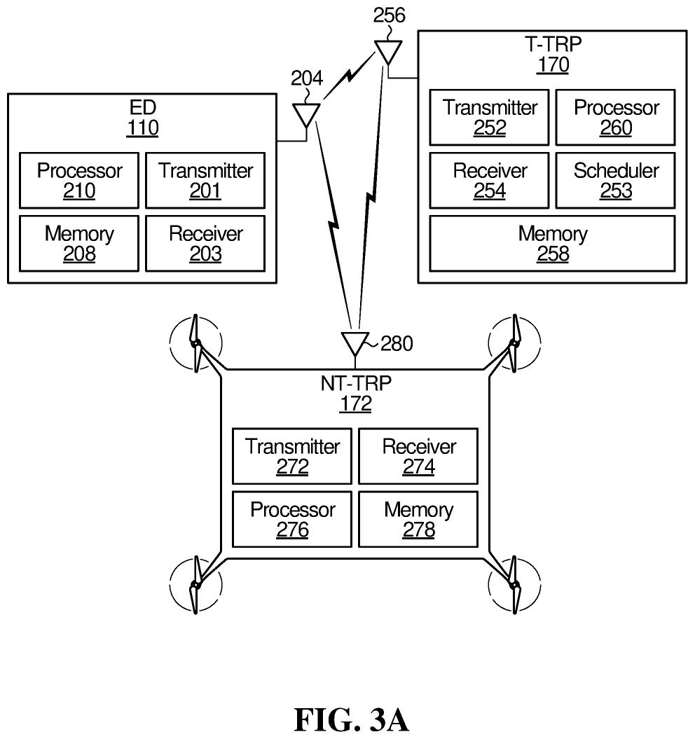

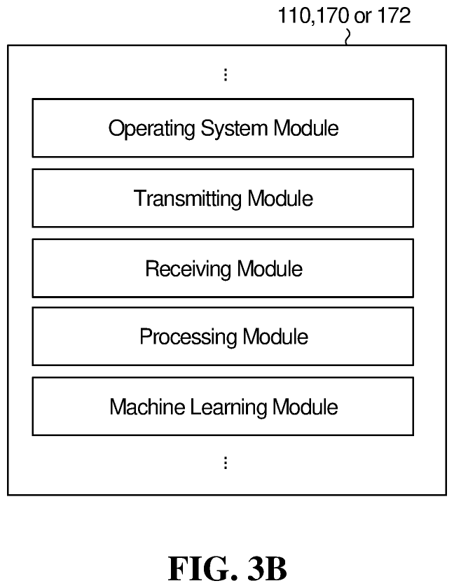

FIGS. 2A, 2B, 3A, and 3B following below provide context for the network and devices that may be in the network and that may implement aspects of the present disclosure.

Referring to FIG. 2A, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-110j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

FIG. 2B illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered subsystems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such technologies.

FIG. 3A illustrates another example of an ED 110 and network devices, including a base station 170a, 170b (at 170) and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an loT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3A, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 2A). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the forging devices, or to apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 3B. FIG. 3B illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

For future wireless networks, a number of the new devices could increase exponentially with diverse functionalities. Also, a lot more new applications and use cases than 5G may emerge with more diverse quality of service demands. These will result in new key performance indications (KPIs) for the future wireless network (for an example, 6G network) that can be extremely challenging, so the sensing technologies, and AI technologies, especially ML (deep learning) technologies, had been introduced to telecommunication for improving the system performance and efficiency.

AI/ML technologies applied communication including AI/ML communication in Physical layer and AI/ML communication in media access control (MAC) layer. For physical layer, the AI/ML communication may be useful to optimize the components design and improve the algorithm performance, like AI/ML on channel coding, channel modelling, channel estimation, channel decoding, modulation, demodulation, MIMO, waveform, multiple access, PHY element parameter optimization and update, beam forming & tracking and sensing & positioning, etc. For MAC layer, AI/ML communication may utilize the AI/ML capability with learning, prediction and make decisions to solve the complicated optimization problems with better strategy and optimal solution, for example to optimize the functionality in MAC, e.g. intelligent TRP management, intelligent beam management, intelligent channel resource allocation, intelligent power control, intelligent spectrum utilization, intelligent MCS, intelligent hybrid automatic repeat request (HARQ) strategy, intelligent transmit/receive (Tx/Rx) mode adaption, etc.

AI/ML architectures usually involve multiple nodes, which can be organized in two modes, i.e., centralized and distributed, both of which can be deployed in access network, core network, or an edge computing system or third-party network. The centralized training and computing architecture is restricted by huge communication overhead and strict user data privacy. Distributed training and computing architecture comprises several framework, e.g., distributed machine learning and federated learning. AI/ML architectures comprises intelligent controller which can perform as single agent or multi-agent, based on joint optimization or individual optimization. New protocol and signaling mechanism is needed so that the corresponding interface link can be personalized with customized parameters to meet particular requirements while minimizing signaling overhead and maximizing the whole system spectrum efficiency by personalized AI technologies.

Further terrestrial and non-terrestrial networks can enable a new range of services and applications such as earth monitoring, remote sensing, passive sensing and positioning, navigation and tracking, autonomous delivery and mobility. Terrestrial networks based sensing and non-terrestrial networks based sensing could provide intelligent context-aware networks to enhance the UE experience. For example, terrestrial networks based sensing and non-terrestrial networks based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial and non-terrestrial networks, the measured channel data and sensing and positioning data can be obtained by the large bandwidth, new spectrum, dense network and more light-of-sight (LOS) links. Based on these data, a radio environmental map can be drawn through AI/ML methods, where channel information is linked to its corresponding positioning or environmental information to provide an enhanced physical layer design based on this map.

Sensing coordinators are nodes in a network that can assist in the sensing operation. These nodes can be standalone nodes dedicated to just sensing operations or other nodes (for example TRP 170, ED 110, or core network node) doing the sensing operations in parallel with communication transmissions. A new protocol and signaling mechanism is needed so that the corresponding interface link can be performed with customized parameters to meet particular requirements while minimizing signaling overhead and maximizing the whole system spectrum efficiency.

AI/ML and sensing methods are data-hungry. In order to involve AI/ML and sensing in wireless communications, more and more data are needed to be collected, stored, and exchanged. The characteristics of wireless data expand quite large ranges in multiple dimensions, e.g., from sub-6 GHz, millimeter to Terahertz carrier frequency, from space, outdoor to indoor scenario, and from text, voice to video. These data collecting, processing and usage operations are performed in a unified framework or a different framework.

Aspects of the present disclosure propose using different pilot sequences that are tailored to hardware capabilities of the receiver. Specifically, pilot sequences that can provide improved channel estimation for different resolutions of the ADC, i.e. both high resolution ADC and low or 1 bit ADC, used at the receiver side. The transmitter in the embodiments of the present disclosure may have the capability to choose between different pilot sequences to the receivers, and this allows transmitter to choose the sequence that can provide a better channel estimation at the receiver.

An example for how the pilot sequences can be tailored to the hardware at the UE will be explained in the following examples. Because communication signals between a transmitter and a receiver can be complex valued, i.e. the value having a real component and an imaginary component, a receiver may have a first ADC for processing the real component and a second ADC for processing the imaginary component. A UE with 1-bit ADC for processing each of the real and imaginary components may have a threshold of transitioning from a first quantization value to a second quantization value set to zero. Therefore, any time the threshold is crossed the ADC can be considered to be transitioning from one quantization region to another quantization region.

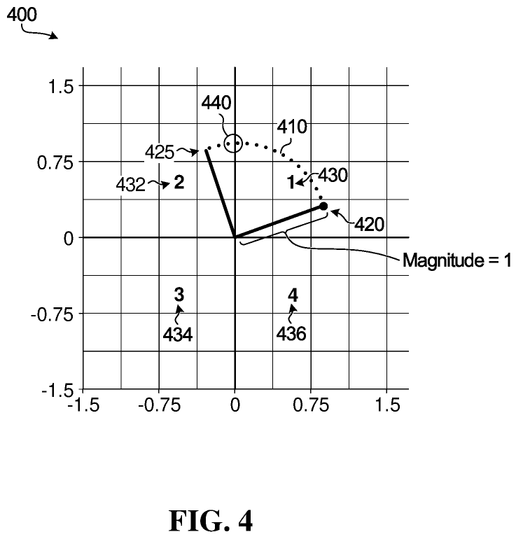

FIG. 4 shows a plot of received pilot symbols of a pilot sequence (represented by each of the dots on the arc of dots 410) that has traversed a communication channel. The pilot symbols of the pilot sequence have a varying phase angle and constant amplitude. The plot of the received pilot symbols is shown on a real and imaginary plane 400. A first received pilot symbol in the example of FIG. 4 has a complex value 420 (0.66556+j 0.18593). The further received pilot symbols are based on the sequence of pilot symbols of magnitude equal to one and an increasing angle from 0° to 90°. It is assumed that there is no noise at the receiver to simplify the explanation. However, the same concepts can be shown analogously for practical receivers. The diagram axes of the real and imaginary plane 400 represent the real and the imaginary components of a complex value received signal. The complex valued received signal is quantized into four regions, a first quadrant 430, a second quadrant 432, a third quadrant 434 and a fourth quadrant 436. The received signal estimate based on a first pilot symbol of a pilot sequence having traversed the channel initially has a quantization value associated with the first quadrant 430. As the angle of the pilot symbols in the pilot sequence increases from 0° to 90°, the value of the received signal transitions from the first quadrant 430 to the second quadrant 432. According to this pilot sequence with the rotating pilot, the angle, in relation to the starting point of the pilot sequence, of the received signal at which the pilot symbol changes the received signal from the first quadrant 430 to the second quadrant 432 is between the two encircled points 440 in FIG. 4. We may use the value of the pilot symbols of the encircled received points to estimate the channel phase angle. In some embodiments, the phase angle of the channel can be estimated to an accuracy proportional to a step size of the phase angles of the pilot sequence.

FIG. 4 is an example of a pilot sequence that is tailored to a 1-bit ADC at the receiver with the threshold set to zero. A sequence of the type shown in FIG. 4 provides a better estimate for the phase angle of the channel when compared to, for example, a pilot sequence in which the individual elements of the sequence have a same fixed angle.

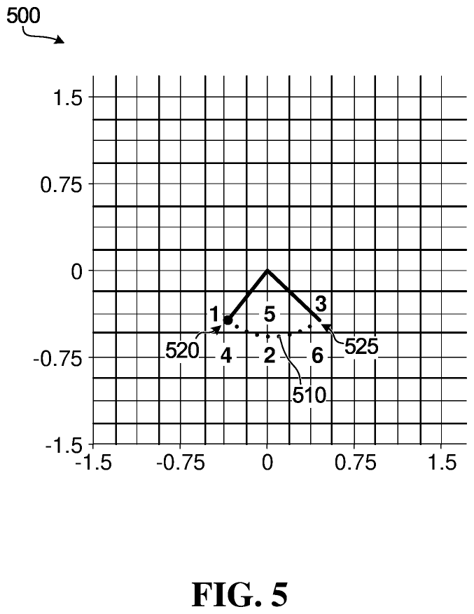

FIG. 5 illustrates another example of received pilot symbols (represented by each of the dots on the arc of dots 510). The sequence of pilot symbols has a constant amplitude and varying phase angle. In FIG. 5 there are more than four quantization regions as there were in FIG. 4. Several of the quantization areas are indicated as regions 1, 2, 3, 4, 5 and 6. A starting received pilot symbol is represented by initial channel point 520 on the complex plane 500. The further received pilot symbols are based on the pilot symbols of the sequence having a magnitude of one and a phase angle that varies from 0° to 90°. Accordingly, the received pilot symbols appear to rotate from the initial position 520 to position 525 over the course of the transmission of the pilot symbols in the pilot sequence. With multiple quantization regions, several of which are identified in FIG. 5 as quantization regions 1, 2, 3, 4, 5 and 6, it can be seen that since the pilot symbols of the pilot sequence that traverse the complex channel are quantized to regions 1, 2, and 3 as the received signal rotates through the complex plane 500, but do not traverse quantization regions 4, 5, and 6, there is a very small range of possible amplitudes and phase angles for that channel value that can result in this arrangement of quantization regions.

While FIGS. 4 and 5 appear to show the pilot symbols in the pilot sequence increasing in angle in a clockwise direction, the angle could increase in a counter-clockwise direction in uniform or non-uniform steps or could be randomly shifting. Also, the amplitude of the pilot sequence can have uniform or non-uniform steps or could be randomly shifting.

In some embodiments, instead of using a pilot sequence to estimate a point in the complex domain, a pilot sequence can be used to estimate a “footprint” of a changing pilot, thereby making it possible to obtain more information. The footprint can be customized to the ADC capabilities at the receiver. Quantization can be considered to introduce quantization noise in addition to thermal noise. Since, one way to mitigate thermal noise is by averaging over multiple samples, estimating a “footprint” of the changing pilot can be considered as trying to quantize the channel to different quantization regions so that the quantization noise may also be averaged over the different samples.

Selecting a pilot sequence that best suits the type of the ADC at the receiver depends on consideration of ADC properties such as the size of the n-bit ADC word, decision boundaries for quantization regions, quantization outputs, sampling rate, oversampling ratio, required accuracy and other attributes related to the ADC and the receiver hardware.

While particular examples are described for a transmitter sending a pilot sequence and a receiver estimating the channel coefficient, it should be understood that aspects of the disclosure can apply to any type of link, such as UL, DL, sidelink or backhaul. Depending on the type of link, the hardware capability of the receiver may be different. The quantization value can be the channel or a weighted version of the channel, e.g., analog beamforming, or a scaled version of the channel, e.g., using automatic gain control (AGC), or any other raw or processed value(s). The transmitter/receiver system can be frequency division duplex (FDD) or time divisional duplex (TDD).

Several different examples of pilot sequences are described below having variable phase angle, variable amplitude, a range of amplitudes, or some combination thereof.

In some embodiments, the pilot sequence has a sequence of pilot symbols, the pilot symbols having a varying phase angle that has a range of Φₘᵢₙ to Φₘₐₓ and a varying amplitude that has a range of Aₘᵢₙ to Aₘₐₓ. The selection of the amplitude range may depend on factors such as application of AGC and channel characteristics. The selection of the range of phase angle may depend on factors such as ADC resolution.

In a particular example, for 1 bit ADC (wherein one ADC is used for processing a real component and one ADC is used for processing an imaginary component), the range of phase angle may span at least 90° to ensure that there is a change from one quantization region to another. This is true for example when the threshold of change is set to zero. For a higher resolution ADC, lower overall phase angle change may be used to change from one quantization region to another. For a 1 bit ADC, in some embodiments, a higher amplitude in the range of Aₘᵢₙ to Aₘₐₓ may be used. For higher resolution ADCs, the amplitude may vary more than for lower resolution or 1 bit ADC. For ADCs having a higher resolution, i.e. more bits per output word, to change from one quantization region to another, both amplitude and phase angle can change. In some embodiments, to increase overall signal to interference plus noise ratio (SINR), higher amplitudes can be used.

In some embodiments, the transmitter may use a pilot sequence that is optimal in some sense for a given receiver. When multiple receivers are present, the transmitter may use a sequence that may suit some of the receivers (for example to broadcast CSI-RS to many users).

In some embodiments, the change from one pilot symbol to another may be used to convey additional information, e.g., control information. A pilot sequence that contains symbols of a constant amplitude and phase angle values such as 90°, 0°, 90° and 0° may be used to inform the receiver of particular control information and another sequence of a constant amplitude and phase angle values such as 90°, 90°, 90° and 90° informs the receiver of different control information. In some embodiments, a particular arrangement of phase angles, which can be determined at the receiver in the form of a transition between different quantization regions is known by the receiver to correspond to a particular control message or channel parameter. The receiver may obtain such messages from transitions between the different quantization regions as the pilot symbols angles change or the lack thereof of there are no transitions. The messages can be, but are not limited to, information regarding the channel or control information.

Pilot sequences, for example, pilot sequences that may result in a sequence with constant amplitude, zero auto correlation (CAZAC), usually have constant amplitude and varying phase angle. However, the use of constant amplitude and varying phase angle pilot sequences is typically to provide spectrum compactness, not to match the hardware at the receiver side. This can be useful for receivers with high resolution ADC that have flat or frequency selective channels. A channel that is considered flat has similar channel coefficients over a broad range of frequency. A channel that is considered frequency selective has varying channel coefficients over frequency because the coefficients are frequency dependent. In some embodiments, different phase angle patterns and/or phase angle sizes can be utilized for different pilot sequences, which are orthogonal to each other, for different receivers. Examples of different patterns, not intended to be limiting may include different angle ranges, i.e. 0° to 90° for a first receiver, 0° to 180° for a second receiver, 0° to 270° for a third receiver, or different starting phase angle, i.e. 0° to 90° for a first receiver, 90° to 180° for a second receiver, 180° to 270° for a third receiver.

In some embodiments, a mother pilot sequence can be used in which the phase angle changes between pilot symbols slowly from Φₘᵢₙ to Φₘₐₓ (e.g. from 0° to 90°). The mother sequence is considered a main sequence. Variant pilot sequences can be generated based on this main sequence. For example, variant pilot sequences may depend on a specific seed that change the phase angle values in the pilot sequence. The step size for the phase angle change between pilot symbols can be linear or non-linear. In some embodiments, a cover sequence can be applied with different phase angles, e.g., [0°, 90°, 180°, 270°]. A cover sequence is a sequence pseudo randomizer or a sequence spreader. Such a sequence spreader is a known and pseudo random sequence that is multiplied by the original sequence to perform one or more of spreading the bandwidth, encrypting the sequence, or orthogonalizing the sequence between different users/cells/transmitters. The cover sequence may be based on a pseudo-random sequence with a UE specific seed or a cell specific seed.

In some embodiments, the symbols of the reference sequence are arranged in: a non-sequential arrangement of phase angle from symbol to symbol in the range of Φmin to Φmax; or a sequential arrangement of phase angle that is increasing or decreasing from symbol to symbol in the range of Φmin to Φmax. The pilot symbols of the pilot sequence may be shuffled so that the phase angles do not necessarily occur with a consistent spacing (i.e. the phase angles are not in a sequential arrangement) and/or consistent increasing angle direction or decreasing angle direction. This may result in the appearance of the phase angle having a somewhat random arrangement of phase angle values in the pilot sequence between Φₘᵢₙ to Φₘₐₓ. For example, while the phase angle may occur over 900 or more, a phase angle value for a first pilot symbol may be 0°, for a second pilot symbol may be 10°, for a third pilot symbol may be 5°, for a fourth pilot symbol may be 20°, for a fifth pilot symbol may be 15°, etc. Using different shuffling patterns for different receivers can randomize the interference between the different receivers. In some embodiments, the shuffling sequence may be based on a pseudo-random sequence with a UE specific seed or a cell specific seed.

The pilot sequences of pilot symbols having constant amplitude and varying phase angles can be useful for many applications. For example, such pilot sequences can be used when the channel amplitude is not particularly important, and the phase angle is to be determined with accuracy. It can also be used with a 1 bit ADC that has zero threshold, since the amplitude information is typically lost. In some embodiments, these type of sequences are applicable to relatively flat channels. Pilot sequences based on the above properties may also be used for high resolution ADCs.

In some embodiments, both phase angle and amplitude of pilot sequences may change. A mother pilot sequence can be used that has a varying phase angle that changes slowly from Φₘᵢₙ to Φₘₐₓ (e.g. from 0° to 90°) and a varying amplitude from Aₘᵢₙ to Aₘₐₓ. Steps of the phase angle of the pilot symbols and steps of the amplitude of the pilot symbols may be equally spaced or non-linear. The phase angle and amplitude can move in the same direction or a different directions to make a path in a sub-space (e.g. the first quadrant). Because very low amplitudes of the pilot symbol can result in the received signal appearing closer to the noise level, larger amplitude levels may be used in one example. Given that different ADCs may have different capabilities, different pilot sequences can be chosen for different receivers. Channel estimation capabilities may include ADC properties of the receiver including one or more of: ADC number of bits; decision threshold boundaries; quantization outputs; sampling rate; oversampling ratio; or desired accuracy.

In some embodiments, a cover sequence can be applied with different phase angles, e.g., [0°, 90°, 180°, 270°]. The cover sequence may be based on a pseudo-random sequence with a UE specific seed or a cell specific seed.

In such embodiments, the sequence of pilot symbols can be shuffled. Using different shuffling patterns for different receivers can randomize the interference between the different receivers. The shuffling sequence may be based on a pseudo-random sequence with a UE specific seed or a cell specific seed.

The pilot sequences of varying amplitudes and phase angles can be useful for many applications. For example, such sequences can be used with a medium resolution ADC to retrieve both amplitude and phase angle information. A medium resolution ADC is an ADC that has a 3 bit or 4 bit resolution as compared to a low resolution ADC having 1 bit or 2 bit resolution and a high resolution ADC having 5 bit or more than 5 bit resolution. In some embodiments, these type of sequences are applicable for flat channels. For a 1 bit ADC, when the threshold is set to a non-zero value, varying amplitude and phase angle sequences can be used to determine amplitude information about the complex channel.

In some embodiments in which the pilot sequence has pilot symbols having constant amplitude and a variable phase angle, the pilot sequence can be used for determining channel estimates of a narrow band channel (i.e. in a frequency selective channel). In some embodiments, a mother pilot sequence can be used in which the phase angle changes slowly from Φₘᵢₙ to Φₘₐₓ (e.g. from 0° to 90°). A step size for the phase angle change can be linear or non-linear. A sequence cover can be applied with different phase angles, e.g., [0°, 90°, 180°, 270°]. The cover sequence may be based on a pseudo-random sequence with a UE specific seed or a cell specific seed.

In some embodiments, the pilot symbols in the pilot sequence can be shuffled. Using different shuffling patterns for different receivers can randomize the interference between the different receivers. The shuffling sequence may be based on a pseudo-random sequence with a UE specific seed or a cell specific seed.

The sequences of constant amplitude and varying phase angles can be useful for many applications. For example, a constant amplitude and varying phase angle sequence can be used when the channel amplitude is not important, and the phase angle is to be determined with a particular level of accuracy. A constant amplitude and varying phase angle pilot sequence can also be used with a 1 bit ADC that has zero threshold, since the amplitude information is typically lost. Pilot sequences based on the above properties may also be used for high resolution ADCs.

If shuffling is used in this embodiment for a frequency selective channel, the shuffling is done in a way that the bandwidth (BW) is maintained to be narrow. Phase angle variations and step sizes also needed to be selected so that the BW is maintained to be narrow. Such embodiments are useful when applying frequency division multiplexing (FDM) channel estimation for highly frequency selective channels. In such a case, channel estimation can be performed for different frequency bands of the channel separately and then interpolation can be applied to determine the channel estimate at other frequency locations.

In some embodiments in which the pilot sequence has pilot symbols having a variable amplitude and a variable phase angle, the pilot sequence can be used for determining channel estimates of a narrow band channel (i.e. in a frequency selective channel). A mother pilot sequence can be used in which the phase angle changes slowly from Φₘᵢₙ to Φₘₐₓ (e.g. from 0° to 90°) and the amplitude from Aₘᵢₙ to Aₘₐₓ. The phase angle and amplitude steps of the pilot symbols can be equally spaced or non-linear. The phase angle and amplitude can move in the same direction or a different direction to make a path in a sub-space (e.g. the first quadrant). Because very low amplitudes can result in the received signal appearing closer to the noise level, it is recommended to use larger amplitude levels. Given that different ADCs have different capabilities, different pilot sequences can be chosen for different receivers.

In some embodiments, a sequence cover can be applied with different phase angles, e.g., [0° 90° 180° 270°]. The cover sequence may be based on a pseudo-random sequence with a UE specific seed or a cell specific seed.

In some embodiments, the pilot sequence can be shuffled. Using different shuffling patterns for different receivers can randomize the interference between different receivers. The shuffling sequence may be based on a pseudo-random sequence with a UE specific seed or a cell specific seed.

The pilot sequences of varying amplitudes and phase angles can be useful for many applications. For example, such sequences can be used with a medium resolution ADC to retrieve both amplitude and phase angle information. For a 1 bit ADC, when the threshold is set to a non-zero value, varying amplitude and phase angle sequences can be used to determine the amplitude information.

If shuffling is used for a frequency selective channel the pilot sequence has pilot symbols having a variable amplitude and a variable phase angle for channel estimates of narrow band, the shuffling is be done in a way that the BW is maintained to be narrow. Phase angle variations and step sizes also needed to be selected so that the BW is maintained to be narrow. This embodiment is useful when applying FDM channel estimation for highly frequency selective channels. In such a case, channel estimation can be performed for different frequency bands of the channel separately and then interpolation can be applied to determine the channel estimate at other frequency locations.

In some embodiments, a mother pilot sequence can be used in which the phase angle changes slowly from Φₘᵢₙ to Φₘₐₓ (e.g. from 0° to 90°) and multiple constant amplitudes from a set of constant amplitude values ([A₁ . . . A_{N}], where Aᵢ for i=1 to N are different amplitudes) can be used. The steps for the phase angle can be equally spaced or non-linear. A particular example for such an embodiment would be a first set of pilot symbols in the pilot sequence having a variable phase angle at a first constant amplitude A₁ concatenated with a second set of pilot symbols in the pilot sequence having a variable phase angle at a second constant amplitude A₂. This can result in a first set of received pilot symbols that trace an arc (in the same manner as received pilot symbols 410 in FIG. 4 and received pilot symbols 510 in FIG. 5) resulting from pilot symbols in the pilot sequence having the variable phase angle at the first amplitude A₁ and a second set of received pilots symbols that trace an arc resulting from pilot symbols in the pilot sequence having the variable phase and at the second amplitude A₂. The first and second sets of pilot symbols having the varying phase angle values at the different constant amplitudes may cover the same phase angle range, or may each cover different phase angle range. The number of samples for different sets of pilot symbols in the pilot sequence may be the same or different. The phase angle step of the pilot symbols in each set of pilot symbols can be in the same or different directions from that of other sets of pilot symbols in the pilot sequence to make a path in a sub-space. Because low amplitudes can result in the received signal appearing to be closer to the noise level, in some embodiments, it is recommended to use larger amplitude levels. Given that different ADCs have different capabilities, different sequences can be chosen for different receivers.

In some embodiments, a sequence cover can be applied with different phase angles, e.g., [0° 90° 180° 270°]. The cover sequence may be based on a pseudo-random sequence with a UE specific seed or a cell specific seed.

In some embodiments, the pilot sequence can be shuffled. Using different shuffling patterns for different receivers can randomize the interference between different receivers. The shuffling sequence may be based on a pseudo-random sequence with a UE specific seed or a cell specific seed.

The pilot sequences of varying amplitudes and phase angles can be useful for many applications. For example, such sequences can be used with a medium resolution ADC to retrieve both amplitude and phase angle information. For a 1 bit ADC, when the threshold is set to a non-zero value, varying amplitude and phase angle sequences can be used to retrieve the amplitude information.

Embodiments using this technique can be applied when the channel is flat or for frequency selective channels.

Utilizing pilot sequences that are well tailored to the hardware capabilities of the receiver, especially the capabilities of the ADC, can provide a better estimate for the channel coefficient(s) and accordingly, more reliable communication.

The following section provides an explanation of a relationship between some communication system parameters and pilot sequence selection. Several relationships are discussed to show how the pilot sequence selection can depend on system parameters. However, while the relationship of only a few system parameters are described, similar explanations may apply to other system parameters.

For example, considering the effect of ADC resolution on the selection of pilot sequence, several factors are worth discussion. When quantization noise power is high, such as for very low resolution ADCs, it may be preferable to use pilot sequences in which the pilot symbols change phase angle, but not amplitude. If it is able to determine the amplitude, the threshold of the ADC can be set to a non-zero value and a pilot sequence used that has varying amplitude and phase angle to be able to determine the amplitude. When the quantization noise has a medium level, typically the case for medium resolution ADCs, a pilot sequence can be selected having pilot symbols with varying phase angle and amplitude. When the quantization noise is negligible, which is the case for high resolution ADCs, the quantization noise can be ignored and a pilot sequence can be selected in which the pilot symbols change phase angle, but not amplitude.

Another relationship to consider when selecting the pilot sequence is noise value resulting from thermal noise, interference, or other sources. A very low noise level is unlikely to change the quantization region, in contrast to the cases of high noise level, where the received signal may change from one quantization region to another quantization region. Because aspects of the present disclosure are directed to changing from one quantization region to another quantization region, pilot sequences for lower noise levels are recommended that result in more quantization variation than those for higher noise levels.

Another relationship to consider when selecting a pilot sequence is whether the channel is flat or frequency selective. For a flat channel, for example, the pilot sequence can be randomized to increase the BW of the pilot sequence from a narrow band to a wider band to encompass the flat channel bandwidth to be estimated. On the other hand, for frequency selective channels, narrow band pilot sequences can be used in conjunction with interpolation in order to obtain an estimate of the channel at additional frequency locations.

Because the selection of the pilot sequence may depend on various factors, the transmitter can consider these factors, and support different pilot sequences and mechanisms. In some embodiments, the network may estimate a signal to noise ratio (SNR) and quantization noise then the network can notify the receiver about a selected pilot sequence. Estimating SNR and the quantization noise may be based on one or more of measurements made by the network, receiver feedback, and receiver capability. The receiver feedback is information sent by the receiver after the receiver has measured received signals from the transmitter. The information may include received signal power and receiver noise estimates, for example. Receiver capability includes information about the type and capabilities of ADC used in the receiver, as well as other relevant parameters. The notification may include information such as, but not limited to, pilot sequence parameter settings, seeds for randomization, and shuffling pattern information. In some embodiments, the signalling of the notification information may be semi-static and can use, for example radio resource control (RRC) signalling. In some embodiments, the signalling of the notification information may be dynamic so as to update parameters such as, but limited to, the experienced SINR and the number of arcs in the multi-arc pilots. Dynamic signalling may be performed using, for example, a media access control—control element (MAC-CE) or downlink control information (DCI).

Different types of reference signals, the choice of pilot sequence may be impacted by a communication scheme for low resolution ADC. For example, channel state information reference signals (CSI-RS), sounding reference signals (SRS) and DL/UL demodulation reference signals (DMRS) may use different pilot sequences.

Providing the communication system with pilot sequences that are tailored to the hardware capabilities of the receiver, especially the receiver ADC, can result in a better estimate for the channel coefficient(s) and accordingly, more reliable data communication. The choice of the pilot sequence can be affected by the communication system parameters, which for some pilot sequence selections can further enhance the channel estimate and therefore the reliability of data communication.

Some embodiments of the disclosure provide methods for mapping a selected pilot sequence to channel resources.

In some embodiments, the pilot sequence is inserted into a transmission frame so that the symbols of the pilot sequence occur consecutively with one another in a complete sequence. This approach is suitable for both narrow band and wide band scenarios. In some embodiments, when the symbols of the pilot sequence occur consecutively, the same pulse shaping may be used for both the pilot symbols of the pilot sequence and data. Pulse shaping here refers to pulse shaping that may be used for mapping digital symbols to analog symbols with frequency limited to a certain band.

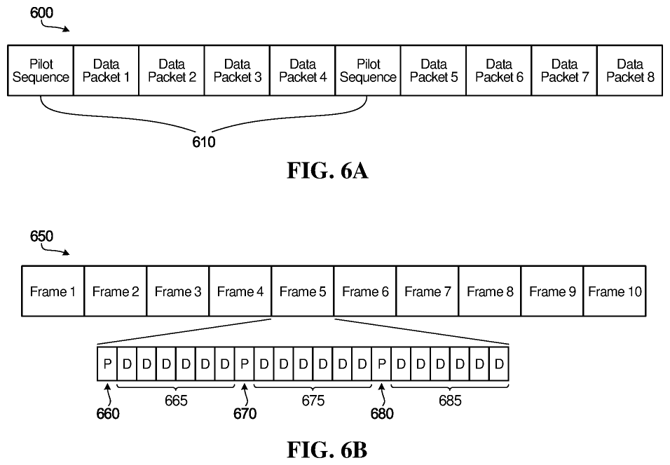

FIG. 6A is an example illustrating a representation of a channel resource 600 in which pilot sequence 610 is included in the channel resource 600 between select data packets. In particular, the pilot sequence 610 is mapped to a first transmission resource portion, followed by Data Packet 1, Data Packet 2, Data Packet 3, and Data Packet 4 being mapped to subsequent transmission resource portions. Then another pilot sequence 610 is mapped to the channel resource 600 followed by Data Packet 5, Data Packet 6, Data Packet 7, and Data Packet 8. In some embodiments, when pilot symbols of the pilot sequence occur consecutively, a first pulse shaping can be used for the pilot sequence and a second pulse shaping can be used for the data. In some embodiments, guard symbols may be inserted between the pilot sequence and the data symbols.

In some embodiments, the pilot sequence may be mapped to the channel resource by interleaving of the symbols of the pilot sequence with the data. In such a scenario, the pilot sequence is mapped within the frame structure with the data. FIG. 6B is an example of a channel resource 650 included multiple frames, Frame 1 to Frame 10, in which each frame includes interleaved pilot symbols of the pilot sequence and the data. For example, looking in particular at Frame 5, a first pilot symbol 660 of the pilot sequence is mapped to a first portion of the frame, followed by six data symbols 665 being mapped to subsequent portions of the frame. Another pilot symbol 670 is mapped to Frame 5 of the channel resource 650 followed by six data symbols 675 being mapped to subsequent portions of the frame. Another pilot symbol 680 is mapped to the channel resource 650 of Frame 5 followed by six data symbols 685 being mapped to subsequent portions of the frame. Due to the pilot sequence being mixed with data, bandwidth expansion may occur, which is not an issue for wideband flat channels. In some embodiments, guard symbols may be added before each pilot symbol or after each pilot symbol, or both. Guard symbols allow a spacing between the pilot symbols and data symbols. The same pulse shaping may be used for both the data and pilot symbols.

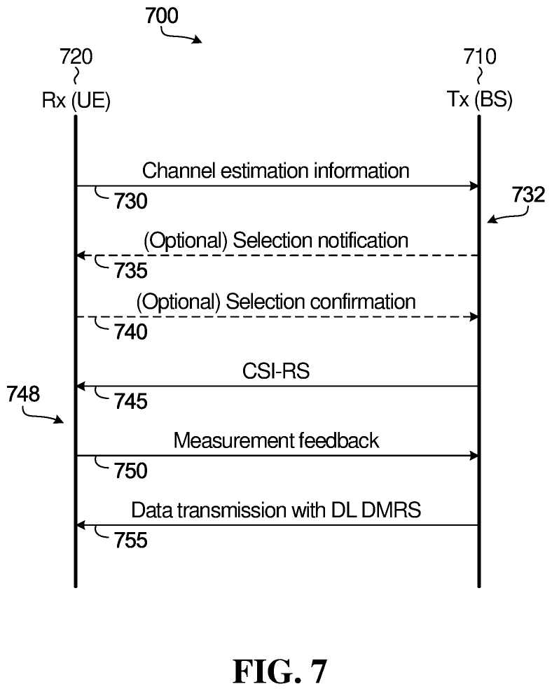

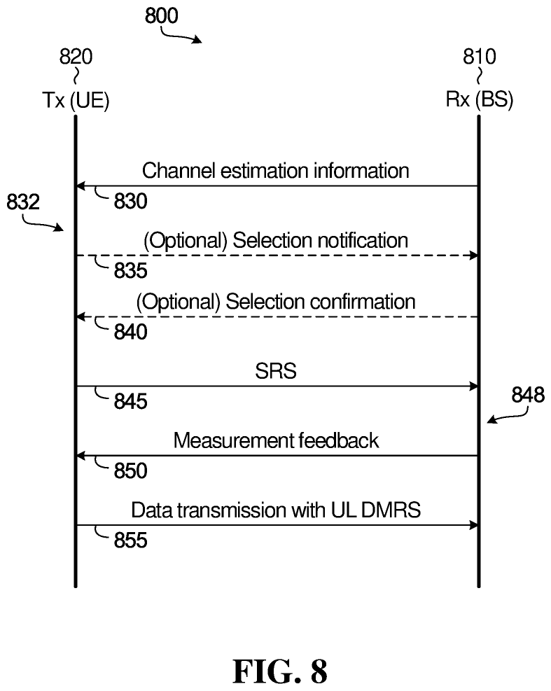

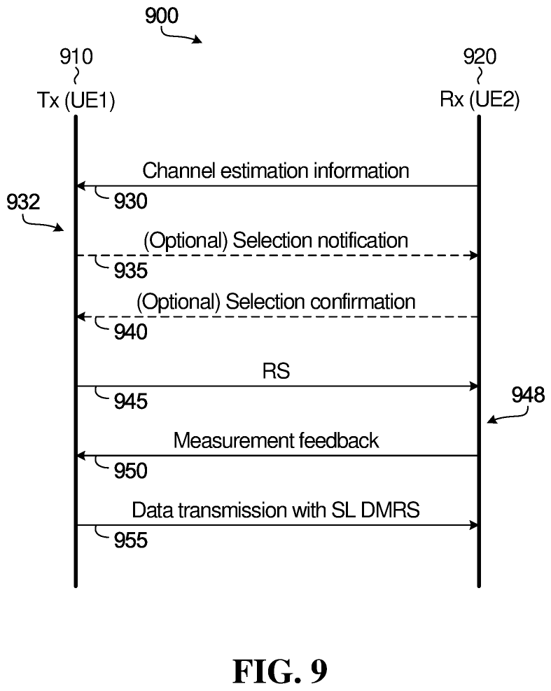

Some embodiments of the disclosure provide a method for signalling between a transmitter and a receiver to exploit benefits from a choice of pilot sequence. FIGS. 7, 8, and 9 illustrate three signaling flow diagrams between a transmitter and a receiver. In the scenario of a downlink (DL) communication 700 in FIG. 7, the receiver is a UE 720 and the transmitter is a base station (BS) 710. In the scenario of an uplink (UL) communication 800 in FIG. 8, the receiver is a base station 810 and the transmitter is a UE 820. In the scenario of a sidelink (SL) communication 900 in FIG. 9, the transmitter is a first UE UE1 910 and the receiver is a second UE UE2 920.

In these embodiments, the signaling diagrams illustrate the cases when the transmitter decides which reference signal is to be used. It should also be understood that, in some embodiments, the receiver may make the decision regarding the selection of the pilot sequence to be used, or the network may make the decision regarding the selection of the pilot sequence to be used.

FIG. 7 is a signal flow diagram 700 illustrating the signalling between the base station 710 and the UE 720 that eventually results in a DL transmission. Part of the signalling in the signal flow diagram 700 includes selection of a pilot sequence that is appropriate for the UE 720, notifying the UE 720 of the selected pilot sequence and use of the selected pilot sequence. In this example the UE 720 is the receiver and the BS 710 is the transmitter.

At step 730, the UE 720 provides channel estimation information to the BS 710.

The channel estimation information may include capability information, for example, an indication of a type of ADC and may include particular parameter information pertaining to the ADC, such as one or more of ADC number of bits, decision threshold boundaries; quantization outputs; sampling rate; oversampling ratio; and desired accuracy. In some embodiments, the channel estimation information may include a selection made at the receiver of a reference signal from a set of one or more reference signals that the receiver proposes the transmitter use as the reference signal. The channel estimation information may be sent in a higher-layer message, such as, for example, an RRC message.

According to the channel estimation information, the BS 710 decides 732 which type of reference signal to use and the pilot sequence by selecting a reference signal to be transmitted to the UE 720 that is consistent with one of the various embodiments described above. In some embodiments, the selecting the reference signal involves the transmitter selecting the reference signal from a plurality of reference signals, wherein the selecting is performed based on channel estimation capabilities of the receiver provided in the channel estimation information received from the receiver. In some embodiments, the selecting the reference signal involves the transmitter selecting the reference signal as determined by the receiver and provided as a proposed reference signal in the channel estimation information received from the receiver. The set of reference signals includes reference signals that are suitable for at least one: different ADC resolutions; different signal to noise ratio (SNR)/signal and interference to noise ratio (SINR) values; or different operating bandwidths. In some embodiments, selecting the set of reference signals further involves estimating SNR and quantization noise based on one or more of: measurements made by the transmitter; channel estimation capabilities of a receiver; measurement information received from the receiver; and default estimate values.

Step 735 is an optional step in which the BS 710 notifies the UE 720 of the decision by transmitting an indication of the selected reference signal to the UE 720. In some embodiments, the indication is an identification of the reference signal selected by the transmitter. In some embodiments, the indication is an acknowledgement of the reference signal selected by the receiver. This notification may be sent in a higher-layer message, such as, for example, an RRC message.

Also, optionally, for example when the transmitter has selected the reference signal and expects an acknowledgement from the receiver, at step 740, the UE 720 may send a confirmation of receipt of the notification 735 to the BS 710. The confirmation may be sent in a higher-layer message, such as, for example, an RRC message. The BS 710 then starts the channel estimation process.

At step 745, the BS 710 sends the reference signal. In the example of FIG. 7, the reference signal that was selected at step 732 and notified to the UE 720 in step 735 is a channel state information reference signal (CSI-RS) with a particular pilot sequence consistent with one of the various embodiments described above.

At step 748, the UE 720 uses the received CSI-RS having the particular pilot sequence to perform a channel measurement.

At step 750, the UE 720 transmits measurement feedback in the form of channel estimation feedback information to the BS 710. Examples of information that may be included in the measurement feedback include, but are not limited to, indicators of the channel value itself, amplitude, phase angle, or both, SNR, and possible rate for communication.

At step 755, the BS 710 sends on PDSCH a data transmission with DL DMRS. In some embodiments, the DL DMRS may be based on the selected pilot sequence.

While FIG. 7 illustrates a sequence of steps that include both channel estimation that included transmission of CSI-RS and transmission of data that includes transmission of DMRS, it should be understood that methods supported by this disclosure may include a method that involves steps shown in FIG. 7 related to channel estimation using CSI-RS and a method that involves steps shown in FIG. 7 related to transmission of data using transmission including DMRS.

FIG. 8 is a signal flow diagram 800 illustrating the signalling between the base station (BS) 810 and the UE 820 that eventually results in an UL transmission. Part of the signalling in the signal flow diagram 800 includes selection of a pilot sequence that is appropriate for the BS 810, notifying the BS 810 of the selected pilot sequence and use of the selected pilot sequence. In this example the UE 820 is the transmitter and the BS 810 is the receiver.

At step 830, the BS 820 provides channel estimation information to the UE 810. The channel estimation information may include capability information for example, an indication of a type of ADC and may include particular parameter information pertaining to the ADC, such as one or more of ADC number of bits, decision threshold boundaries; quantization outputs; sampling rate; oversampling ratio; and desired accuracy. In some embodiments, the channel estimation information may include a selection made at the receiver of a reference signal from a set of one or more reference signals that the receiver proposes the transmitter use as the reference signal. The channel estimation information may be sent in a higher-layer message, such as, for example, an RRC message.

According to the channel estimation information, the UE 820 decides 832 which type of reference signal to use and the pilot sequence by selecting a reference signal from a set of reference signals to be transmitted to the BS 810 that is consistent with one of the various embodiments described above. In some embodiments, the selecting the reference signal involves the transmitter selecting the reference signal from a plurality of reference signals, wherein the selecting is performed based on channel estimation capabilities of the receiver provided in the channel estimation information received from the receiver. In some embodiments, the selecting the reference signal involves the transmitter selecting the reference signal as determined by the receiver and provided as a proposed reference signal in the channel estimation information received from the receiver. The set of reference signals includes reference signals that are suitable for at least one: different ADC resolutions; different SNR/SINR values; or different operating bandwidths. In some embodiments, selecting the set of reference signals further involves estimating SNR and quantization noise based on one or more of: measurements made by the transmitter; channel estimation capabilities of a receiver; measurement information received from the receiver; and default estimate values.

Step 835 is an optional step in which the UE 820 notifies the BS 810 of the decision by transmitting an indication of the selected reference signal to the BS 810. This notification may be sent in a higher-layer message, for example, an RRC message.

Also, optionally, for example when the receiver has selected the reference signal and expects an acknowledgement from the transmitter, at step 840 the BS 810 may send a confirmation of receipt of the notification 835 to the UE 820. The confirmation may be sent in a higher-layer message, such as, for example, an RRC message. The UE 820 then starts the channel estimation process.

At step 845 the UE 820 sends the reference signal. In the example of FIG. 8, the reference signal that was selected at step 832 and notified to the BS 810 in step 835 is a sounding reference signal (SRS) with a particular pilot sequence consistent with one of the various embodiments described above.

At step 848, the BS 810 uses the received SRS having the particular pilot sequence to perform a channel measurement. At step 850 the BS 810 transmits measurement feedback in the form of channel estimation feedback information to the UE 820. Examples of information that may be included in the measurement feedback include, but are not limited to, indicators of the channel value itself, amplitude, phase angle, or both, SNR, and possible rate for communication.

At step 855, the UE 820 sends data and UL DMRS. In some embodiments, the UL DMRS may be based on the selected pilot sequence.

While FIG. 8 illustrates a sequence of steps that include both channel estimation that included transmission of SRS and transmission of data that includes transmission of DMRS, it should be understood that methods supported by this disclosure may include a method that involves steps shown in FIG. 8 related to channel estimation using SRS and a method that involves steps shown in FIG. 8 related to transmission of data using transmission including DMRS.

FIG. 9 is a signal flow diagram 900 illustrating the signalling between the first UE UE1 910 and the second UE UE2 920 for a SL transmission. In this example UE1 910 is the transmitter and the UE2 920 is the receiver

At step 930, the UE2 920 provides channel estimation information to the UE1 910. The channel estimation information may include capability information for example, an indication of a type of ADC and may include particular parameter information pertaining to the ADC, such as one or more of ADC number of bits, decision threshold boundaries; quantization outputs; sampling rate; oversampling ratio; and desired accuracy. In some embodiments, the channel estimation information may include a selection made at the receiver of a reference signal from a set of one or more reference signals that the receiver proposes the transmitter use as the reference signal. The channel estimation information may be sent in a higher-layer message, such as, for example, an RRC message.

According to the capability information, the UE1 910 decides 932 which type of reference signal to use and the pilot sequence by selecting a reference signal from a set of reference signals to be transmitted to UE2 920 that is consistent with one of the various embodiments described above. In some embodiments, the selecting the reference signal involves the transmitter, UE1 910, selecting the reference signal from a plurality of reference signals, wherein the selecting is performed based on channel estimation capabilities of the receiver, UE2 920, provided in the channel estimation information received from the receiver. In some embodiments, the selecting the reference signal involves the transmitter selecting the reference signal as determined by the receiver and provided as a proposed reference signal in the channel estimation information received from the receiver. The set of reference signals includes reference signals that are suitable for at least one: different ADC resolutions; different SNR/SINR values; or different operating bandwidths. In some embodiments, selecting the set of reference signals further involves estimating SNR and quantization noise based on one or more of: measurements made by the transmitter; channel estimation capabilities of a receiver; measurement information received from the receiver; and default estimate values.

Step 935 is an optional step in which the UE1 910 notifies the UE2 920 of the decision by transmitting an indication of the selected reference signal to the UE2 920. This notification may be sent in a higher-layer message, for example, an RRC message.

Also, optionally, for example when the transmitter has selected the reference signal and expects an acknowledgement from the receiver, at step 940 the UE2 920 may send a confirmation of receipt of the notification 935 to the UE1 910. The confirmation may be sent in a higher-layer message, for example, an RRC message. The UE1 910 then starts the channel estimation process.

At step 945 the UE1 910 sends the reference signal (RS). In the example of FIG. 9, the reference signal that was selected at step 932 and notified to the UE2 920 in step 935 is a reference signal with a particular pilot sequence consistent with one of the various embodiments described above.

At step 948, the UE2 920 uses the received reference signal having the particular pilot sequence to perform a channel measurement.

At step 950 the UE2 920 transmits measurement feedback in the form of channel estimation feedback information to the UE1 910. Examples of information that may be included in the measurement feedback include, but are not limited to, indicators of the channel value itself, amplitude, phase angle, or both, SNR, and possible rate for communication. At step 955, the UE1 910 sends data and SL DMRS. In some embodiments, the SL DMRS may be based on the selected pilot sequence.

While FIG. 9 illustrates a sequence of steps that include both channel estimation that included transmission of a reference signal and transmission of data that includes transmission of DMRS, it should be understood that methods supported by this disclosure may include a method that involves steps shown in FIG. 9 related to channel estimation using the reference signal and a method that involves steps shown in FIG. 9 related to transmission of data using transmission including DMRS.

FIGS. 7, 8, and 9 are examples of steps that may be performed in DL, UL and SL, but should not be considered limiting. Other methods may be possible that include the concept of using a pilot sequence that is tailored to a receiver capabilities.

Signalling methods similar to those describe above in the examples for DL, UL and SL may also be used for backhaul.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method comprising:
receiving, by a transmitter, channel estimation information of a receiver;
selecting, by the transmitter, a reference signal to be transmitted to the receiver, wherein the selection is based on the received channel estimation information; and
transmitting, by the transmitter, the selected reference signal to the receiver.

2. The method of claim 1, wherein the reference signal is at least one of a channel state information reference signal (CSI-RS), a sounding reference signal (SRS) and a demodulation reference signal (DMRS) associated with at least one of:
physical downlink shared channel (PDSCH);
physical uplink shared channel (PUSCH); or
physical sidelink shared channel (PSSCH).

3. The method of claim 1, further comprising receiving, by the transmitter, channel estimation feedback information from the receiver.

4. The method of claim 1, wherein the selecting, by the transmitter, a reference signal comprises:
selecting the reference signal from a plurality of reference signals, wherein the selecting is performed based on channel estimation capabilities of the receiver provided in the channel estimation information received from the receiver; or
selecting the reference signal as determined by the receiver and provided as a proposed reference signal in the channel estimation information received from the receiver.

5. The method of claim 1, wherein the reference signal comprises one of:
a reference signal sequence wherein symbols of the reference signal sequence have a varying phase angle ranging rom Φₘᵢₙ to Φₘₐₓ and a constant amplitude, where Φₘᵢₙ is a minimum phase angle and Φₘₐₓ is a maximum phase angle of the varying phase angle;
a reference signal sequence wherein symbols of the reference signal sequence have a varying phase angle from Φₘᵢₙ to Φₘₐₓ and a varying amplitude from Aₘᵢₙ to Aₘₐₓ, where Aₘᵢₙ is a minimum amplitude and Aₘₐₓ is a maximum amplitude of the varying amplitude; or
a reference signal sequence wherein symbols of the reference signal sequence include a plurality of sets of symbols, each set comprising symbols having a varying phase angle from Φₘᵢₙ to Φₘₐₓ and a constant amplitude and each set having a different constant amplitude.

6. The method of claim 5, wherein at least one of the varying phase angle from Φₘᵢₙ to Φₘₐₓ and the varying amplitude from Aₘᵢₙ to Aₘₐₓ of the symbols of the reference signal sequence causes a transition from a first quantization region to a second quantization region when quantized by an analog-to-digital converter (ADC) in the receiver and wherein the transition from the first quantization region to the second quantization region is used to provide control information or channel information to the receiver.

7. The method of claim 5, wherein the symbols of the reference sequence are arranged in:
a non-sequential arrangement of phase angle from symbol to symbol in the range of Φₘᵢₙ to Φₘₐₓ; or
a sequential arrangement of phase angle that is increasing or decreasing from symbol to symbol in the range of Φₘᵢₙ to Φₘₐₓ.

8. The method of claim 5, wherein:
the reference signal sequence occurs with the symbols in the reference sequence being consecutively grouped together in a frame; or
the reference signal sequence occurs with the symbols in the reference signal sequence being interleaved with data.

9. A device comprising:
a processor; and
a computer-readable medium having stored thereon computer executable instructions, that when executed cause the device to:
receive channel estimation information from a receiver;
select a reference signal to be transmitted to the receiver, wherein the selection is based on the received channel estimation information;
transmit the selected reference signal to the receiver.

10. The device of claim 9, wherein the reference signal is at least one of a channel state information reference signal (CSI-RS), a sounding reference signal (SRS) and a demodulation reference signal (DMRS) associated with at least one of:
physical downlink shared channel (PDSCH);
physical uplink shared channel (PUSCH); or
physical sidelink shared channel (PSSCH).

11. The device of claim 9, further comprising computer executable instructions, that when executed cause the device to receive channel estimation feedback information from the receiver.

12. The device of claim 9, wherein the computer executable instructions, that when executed cause the device to select the reference signal cause the device to:
select the reference signal from a plurality of reference signals, wherein the selecting is performed based on channel estimation capabilities of the receiver provided in the channel estimation information received from the receiver; or
select the reference signal as determined by the receiver and provided as a proposed reference signal in the channel estimation information received from the receiver.

13. The device of claim 9, wherein the reference signal comprises one of:
a reference signal sequence wherein symbols of the reference signal sequence have a varying phase angle from Φₘᵢₙ to Φₘₐₓ and a constant amplitude, where Φₘᵢₙ is a minimum phase angle and Φₘₐₓ is a maximum phase angle of the varying phase angle;
a reference signal sequence wherein symbols of the reference signal sequence have a varying phase angle from Φₘᵢₙ to Φₘₐₓ and a varying amplitude from Aₘᵢₙ to Aₘₐₓ, where Aₘᵢₙ is a minimum amplitude and Aₘₐₓ is a maximum amplitude of the varying amplitude; or
a reference signal sequence wherein symbols of the reference signal sequence include a plurality of sets of symbols, each set comprising symbols having a varying phase angle from Φₘᵢₙ to Φₘₐₓ and a constant amplitude and each set having a different constant amplitude.

14. The device of claim 13, wherein at least one of the varying phase angle from Φₘᵢₙ to Φₘₐₓ and the varying amplitude from Aₘᵢₙ to Aₘₐₓ of the symbols of the reference signal sequence causes a transition from a first quantization region to a second quantization region when quantized by an analog-to-digital converter (ADC) in the receiver and wherein the transition from the first quantization region to the second quantization region is used to provide control information or channel information to the receiver.

15. The device of claim 13, wherein the symbols of the reference sequence are arranged in:
a non-sequential arrangement of phase angle from symbol to symbol in the range of Φₘᵢₙ to Φₘₐₓ; or
a sequential arrangement of phase angle that is increasing or decreasing from symbol to symbol in the range of Φₘᵢₙ to Φₘₐₓ.

16. The device of claim 13, wherein:
the reference signal sequence occurs with the symbols in the reference sequence being consecutively grouped together in a frame; or
the reference signal sequence occurs with the symbols in the reference signal sequence being interleaved with data.

17. A method comprising:
transmitting, by a receiver, channel estimation information of the receiver;
receiving, by the receiver, a reference signal, the reference signal selected from a plurality of reference signals based on the channel estimation information;
performing channel estimation, by the receiver, using the received reference signal; and
transmitting, by the receiver, channel estimation feedback information based on the channel estimation.

18. The method of claim 17, further comprising:
selecting, by the receiver, the reference signal from the plurality of reference signals, wherein the selecting is performed based on channel estimation capabilities of the receiver; and
including the selected reference signal in the channel estimation information that is transmitted to the transmitter.

19. The method of claim 17, wherein each reference signal in the plurality of reference signals comprises one of:
a reference signal sequence wherein symbols of the reference signal sequence have a varying phase angle from Φₘᵢₙ to Φₘₐₓ and a constant amplitude, where Φₘᵢₙ is a minimum phase angle and Φₘₐₓ is a maximum phase angle of the varying phase angle;
a reference signal sequence wherein symbols of the reference signal sequence have a varying phase angle from Φₘᵢₙ to Φₘₐₓ and a varying amplitude from Aₘᵢₙ to Aₘₐₓ, where Aₘᵢₙ is a minimum amplitude and Aₘₐₓ is a maximum amplitude of the varying amplitude; or
a reference signal sequence wherein symbols of the reference signal sequence include a plurality of sets of symbols, each set comprising symbols having a varying phase angle from Φₘᵢₙ to Φₘₐₓ and a constant amplitude and each set having a different constant amplitude.

20. The method of claim 19, wherein at least one of the varying phase angle from Φₘᵢₙ to Φₘₐₓ and the varying amplitude from Aₘᵢₙ to Aₘₐₓ of the symbols of the reference signal sequence causes a transition from a first quantization region to a second quantization region when quantized by an analog-to-digital converter (ADC) in the receiver.

21. The method of claim 19, wherein the symbols of the reference sequence are arranged in:
a non-sequential arrangement of phase angle from symbol to symbol in the range of Φₘᵢₙ to Φₘₐₓ; or
a sequential arrangement of phase angle that is increasing or decreasing from symbol to symbol in the range of Φₘᵢₙ to Φₘₐₓ.

22. The method of claim 17, further comprising:
receiving, by the receiver, a demodulation reference signal (DMRS), wherein the DMRS is associated with at least one of:
physical downlink shared channel (PDSCH);
physical uplink shared channel (PUSCH); or
physical sidelink shared channel (PSSCH).

23. The method of claim 19, wherein:
the reference signal sequence occurs with the symbols in the reference sequence being consecutively grouped together in a frame; or
the reference signal sequence occurs with the symbols in the reference signal sequence being interleaved with data.

24. A device comprising:
a processor; and
a computer-readable medium having stored thereon computer executable instructions, that when executed cause the device to:
transmit channel estimation information of the device;
receive a reference signal, the reference signal selected from a plurality of reference signals based on the channel estimation information;
perform channel estimation using the received reference signal; and
transmit channel estimation feedback information based on the channel estimation.

25. The device of claim 24, wherein the computer executable instructions, when executed, cause the device to:
select the reference signal from the plurality of reference signals, wherein the selecting is performed based on channel estimation capabilities of the receiver; and
include the selected reference signal in the channel estimation information that is transmitted to the transmitter.

26. The device of claim 24, wherein each reference signal in the plurality of reference signals comprises one of:
a reference signal sequence wherein the symbols of the reference signal sequence have a varying phase angle from Φₘᵢₙ to Φₘₐₓ and a constant amplitude, where Φₘᵢₙ is a minimum phase angle and Φₘₐₓ is a maximum phase angle of the varying phase angle;
a reference signal sequence wherein the symbols of the reference signal sequence have a varying phase angle from Φₘᵢₙ to Φₘₐₓ and a varying amplitude from Aₘᵢₙ to Aₘₐₓ, where Aₘᵢₙ is a minimum amplitude and Aₘₐₓ is a maximum amplitude of the varying amplitude; or
a reference signal sequence wherein the symbols of the reference signal sequence include a plurality of sets of symbols, each set comprising symbols having a varying phase angle from Φₘᵢₙ to Φₘₐₓ and a constant amplitude and each set having a different constant amplitude.

27. The device of claim 26, wherein at least one of the varying phase angle from Φₘᵢₙ to Φₘₐₓ and the varying amplitude from Aₘᵢₙ to Aₘₐₓ of the symbols of the reference signal sequence causes a transition from a first quantization region to a second quantization region when quantized by an analog-to-digital converter (ADC) in the receiver.

28. The device of claim 26, wherein the symbols of the reference sequence have:
a non-sequential arrangement of phase angle from symbol to symbol in the range of Φₘᵢₙ to Φₘₐₓ; or
a sequential arrangement of phase angle that is increasing or decreasing from symbol to symbol in the range of Φₘᵢₙ to Φₘₐₓ.

29. The device of claim 24, wherein the computer executable instructions, when executed, cause the device to:
receive a demodulation reference signal (DMRS), wherein the DMRS is associated with at least one of:
physical downlink shared channel (PDSCH);
physical uplink shared channel (PUSCH); or
physical sidelink shared channel (PSSCH).

30. The device of claim 26, wherein:
the reference signal sequence occurs with the symbols in the reference sequence being consecutively grouped together in a frame; or
the reference signal sequence occurs with the symbols in the reference signal sequence being interleaved with data.
